(19) United States
(12) Patent Application Publication
(10) Pub. No.: US 2009/0172417 A1
(43) Pub. Date: Jul. 2, 2009

(54) KEY MANAGEMENT METHOD FOR REMOTE COPYING

(76) Inventors: Kyoko Mikami, Kawasaki (JP); Nobuyuki Osaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/033,993

(22) Filed: Feb. 20, 2008

(30) Foreign Application Priority Data
Dec. 26, 2007 (JP) 2007-334266

(51) Int. Cl. G06F 11/30

(52) U.S. Cl. 713/193

(57) ABSTRACT

A computer system comprising a host computer and a first storage system coupled to the host computer. The first storage system includes a first controller for controlling the first storage system, a first volume for storing data written by the host computer and a second volume for storing updated data when the data stored in the first volume is updated The first controller generates update information based on write data contained in the write request upon reception of a write request from the host computer, encrypts the write data based on an encrypted status of the data stored in the second volume and an encryption key for encrypting the data stored in the second volume and stores the generated update information and the encrypted write data in the second volume.

### CLAIM OF PRIORITY

The present application claims priority from Japanese patent application JP 2007-334266 filed on Dec. 26, 2007, the content of which is hereby incorporated by reference into this application.

### BACKGROUND

This invention relates to a computer system, and more particularly to remote copying of data between storage systems.

To prevent a loss of data caused by a failure of a storage system which occurs in the computer system, data stored in a logical volume of the storage system is backed up in a logical volume of a redundantly configured storage system at a remote site. For example, remote copying (or remote mirroring) is known as a technology of backing up data stored in a logical volume.

Specifically, according to the remote copying, data is backed up by defining a set of volumes, i.e., a logical volume (primary logical volume) of a primary storage system and a logical volume (secondary logical volume) of a secondary storage system as a pair volume, and copying data stored in the primary logical volume to the secondary logical volume synchronously or asynchronously. Thus, even when a failure occurs in the primary storage system, the secondary storage system can take over an operation of the primary storage system to receive I/O access from a host computer.

Journaling is known as a technology of backing up and restoring data at a high speed. According to the journaling, upon reception of a data write request (command) from the host computer, data to be written and update information containing time of receiving the write request are stored as journals in a logical volume. The logical volume that stores a journal is called a journal volume.

JP 2005-018506 A discloses a storage system which uses a journaling technology for remote copying. Specifically, a first storage system disclosed in JP 2005-018506 A updates, upon reception of a write command (write request) of data stored in its own volume, the data stored in the volume which has received the write command, creates a journal containing reception time of the write command added to write data, and transfers the created journal to a second storage system. The second storage system updates data stored in its own volume based on the transferred journal. Accordingly, the volume of the first storage system is replicated in the volume of the second storage system.

Through sharing of a journal volume by a plurality of volumes (data volumes) which store data, an order of updating source data volumes can be matched with that of updating destination data volumes.

For reasons of security, data is encrypted to be stored in the storage system. The encryption of data guarantees data confidentiality.

JP 2007-028502 A discloses a storage system which prevents an increase of encrypted data by using the same encryption key when data to be stored in a storage area is encrypted. Specifically, in the storage system that shares data between different storage areas by using a volume mirror function and a snapshot function, if data stored in a source storage area has been encrypted, the encrypted data is decrypted by using an encryption key allocated to the source storage area. Then, the data is encrypted by using an encryption key allocated to a storage area different from the source storage area, and the encrypted data is stored in a destination storage area.

### SUMMARY

A different encryption key may be allocated to a data volume managed by a different administrator. A management volume (e.g., journal volume) may be shared among administrators. When a journal volume is shared among administrators, journals encrypted by different encryption keys are mixed in the journal volume. However, the conventional art has not given any consideration to a case where journals encrypted by different encryption keys are mixed in the same journal volume to be managed.

A representative aspect of this invention is as follows. That is, there is provided a computer system comprising a host computer and a first storage system coupled to the host computer. The first storage system includes a first controller for controlling the first storage system, a first volume for storing data written by the host computer and a second volume for storing updated data when the data stored in the first volume is updated The first controller generates update information based on write data contained in the write request upon reception of a write request from the host computer, encrypts the write data based on an encrypted status of the data stored in the second volume and an encryption key for encrypting the data stored in the second volume and stores the generated update information and the encrypted write data in the second volume.

According to the embodiment of this invention, even when the journals encrypted by the different encryption keys are mixed in the same journal volume, remote copying can be realized through decryption of each journal by a proper encryption key.

### BRIEF DESCRIPTION OF THE DRAWINGS

The present invention can be appreciated by the description which follows in conjunction with the following figures, wherein:

FIG. 1 is a block diagram showing a configuration of a computer system in accordance with a first embodiment of this invention;

FIG. 2 is a block diagram showing a configuration of the storage system in accordance with the first embodiment of this invention;

FIG. 3 is an explanatory diagram showing a pair management table in accordance with the first embodiment of this invention;

FIG. 4 is an explanatory diagram showing a journal group management table in accordance with the first embodiment of this invention;

FIG. 5 is an explanatory diagram showing a configuration of a journal volume in accordance with the first embodiment of this invention;

FIG. 6 is an explanatory diagram showing a journal volume management table in accordance with the first embodiment of this invention;

FIG. 7 is an explanatory diagram showing a encryption management table in accordance with the first embodiment of this invention;

FIG. 8 is an explanatory diagram showing a configuration of update information in accordance with the first embodiment of this invention;

FIG. 9 is a flowchart showing a write command process in accordance with the first embodiment of this invention;

FIG. 10 is a flowchart showing journal transfer process in accordance with the first embodiment of this invention;

FIG. 11 is a flowchart showing a journal read command process in accordance with the first embodiment of this invention;

FIG. 12 is a flowchart showing a restoration process in accordance with the first embodiment of this invention;

FIG. 13 is a block diagram showing a configuration of a computer system in accordance with a second embodiment of this invention;

FIG. 14 is an explanatory diagram showing a replication target management table in accordance with the second embodiment of this invention;

FIG. 15 is an explanatory diagram showing an encryption management table in accordance with the second embodiment of this invention; and

FIG. 16 is a flowchart of a restoration process in accordance with the second embodiment of this invention.

### DETAILED DESCRIPTION OF THE PREFERRED EMBODIMENTS

The preferred embodiments of this invention will be described below referring to the drawings.

### First Embodiment

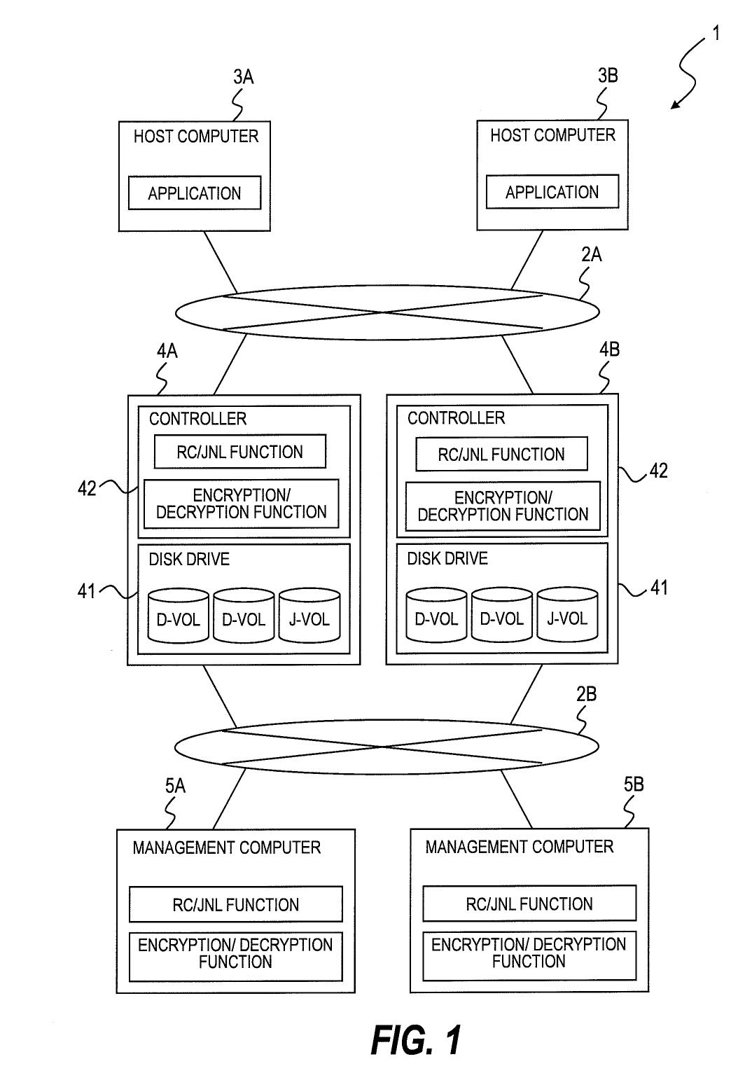

FIG. 1 illustrates a configuration of a computer system 1 according to a first embodiment of this invention.

As shown in FIG. 1, the computer system 1 includes a host computer 3 (3A and 3B), a storage system 4 (4A and 4B), and a management computer 5 (5A and 5B). Hereinafter, when no distinction is made between the host computers 3A and 3B, a host computer may simply be denoted by 3. When no distinction is made between the storage systems 4A and 4B, a storage system may simply be denoted by 4. When no distinction is made between the management computers 5A and 5B, a management computer may simply be denoted by 5.

The host computer 3 and the storage system 4 are intercoupled via a storage network 2A. The storage system 4 and the management computer 5 are intercoupled via a management network 2B. The computer system 1 can be realized as, for example, a bank operation system or an airplane seat reservation system.

The storage network 2A is a network system used for communication based on I/O access between the host computer 3 and the storage system 4. The storage network 2A is also used for communication based on remote copying between the storage systems 4A and 4B.

The storage network 2A can be configured by, for example, one of a LAN and a storage area network (SAN). The storage network 2A includes a network switch and a hub. According to the embodiment, the storage network 2A is configured by a SAN based on a fibre channel protocol (FC-SAN).

The management network 2B is used for communication when the management computer 5 manages the host computer 3 and the storage system 4.

The management network 2B can be configured by, for example, one of a LAN and SAN. The management network 2B includes a network switch and a hub. According to the embodiment, the management network 2B is configured by a LAN based on an IP protocol.

The storage network 2A and the management network 2B do not necessarily have to be configured as physically different networks. For example, when the storage network 2A is configured by a SAN based on an IP protocol, the storage network 2A and the management network 2B can be configured as one network system.

The host computer 3 transmits an I/O access request to the storage system 4 via the storage network 2A, and receives its result. The host computer 3 can be used for, for example, a computer of a bank operation system or an airplane seat reservation system.

The host computer 3 includes hardware resources such as a processor, a memory, a network interface, and a local I/O device, and software resources such as a device driver, an operating system (OS), and an application program.

Under control of the processor, the host computer 3 executes various programs, and cooperates with the other software resources to realize a desired process. For example, in the host computer 3, the processor executes an operation application program on the OS to access a volume of the storage system 4, thereby realizing a desired operation system.

In an example of FIG. 1, the two host computers 3A and 3B respectively access the storage systems 4A and 4B.

The storage system 4 is a subsystem for providing data storage services to the host computer 3, and provides I/O access of data stored in one or more volumes to the host computer 3. The storage system 4 includes one or more disk drives 41 which are physical devices including storage media for holding data, and a controller 42 for controlling I/O access including a write or read request to the disk drive 41.

The storage systems 4A and 4B are similar in configuration, while different operational roles are assigned. For example, the storage system 4A may be a primary storage system 4A activated for a normal operation, while the storage system 4B may be a secondary storage system 4B set on standby to deal with a case where the storage system 4A stops due to a failure or maintenance work. Thus, the same data is stored in a set of pair volumes defined in the primary and secondary storage systems 4A and 4B by remote copying (remote mirroring) described below.

A storage area of the disk drive 41 is divided into a plurality of volumes, or the plurality of volumes are combined. Each volume is a storage area recognized as one logical disk device by an application program of the host computer 3. A physical storage area of an optional capacity included in the disk drive 41 is allocated to each volume.

Redundant arrays of independent disks (RAID) may be configured through division into or combination of a plurality of volumes.

A volume number is allocated to each volume. Accordingly, the host computer 3 specifies a specific volume by using a volume number. For the volume number, a port number and a logical unit number (LUN) are used. A volume is divided into blocks which are minimum units of I/O access, and an address (logical address) is allocated to each block. The host computer 3 can access data stored in a specific block of a specific volume by designating a volume number and an address (logical address).

The storage system 4 includes volumes according to purposes and uses. According to the embodiment, the storage system 4 includes one or more data volumes (D-VOL) for storing data based on I/O access from the host computer 3, and one or more journal volumes (J-VOL) for storing journals generated by using a journaling function.

The storage system 4 includes a RC/JNL function and an encryption/decryption function.

The RC/JNL function uses the journaling function for remote copying. Specifically, upon reception of a remote copying request from the secondary storage system 4B, the primary storage system 4A transfers a journal stored in a journal volume to the storage system 4B. The storage system 4B stores the received journal in its journal volume. A data volume of the secondary storage system 4B is periodically updated based on the stored journal.

The journaling function is for backing up data stored in the data volume at a high speed, and mounted in the storage system 4. Upon reception of a write request from the host computer 3, the storage system 4 stores, through the journaling function, write data contained in the received write request and update information generated based on the write request as journals in the journal volume. The write data is data contained in the write request to be written.

The update information is for managing the write data, and contains time (timestamp) of receiving a write command (write request), a journal group number of a journal group to which a data volume belongs, a sequential number indicating an update order of data stored in the data volume which belongs to the journal group, a volume number and an address of a data volume designated by the write request, a size (volume) of write data contained in the write request, and a volume number and an address of a journal volume which has stored the write data contained in the write request.

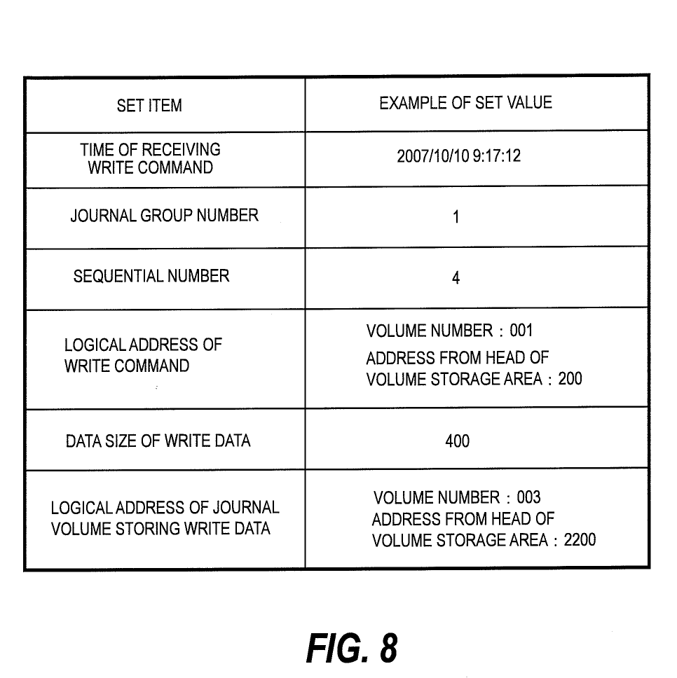

FIG. 8 illustrates a structure of update information according to the first embodiment of this invention. In addition to items shown in FIG. 8, an encrypted status of write data, and an identifier for identifying a journal encryption key used for encrypting the write data may be included. When information for identifying a journal encryption key is used, identification information has to be allocated to each encryption key. The encrypted status of the write data is information indicating whether the write data has been encrypted.

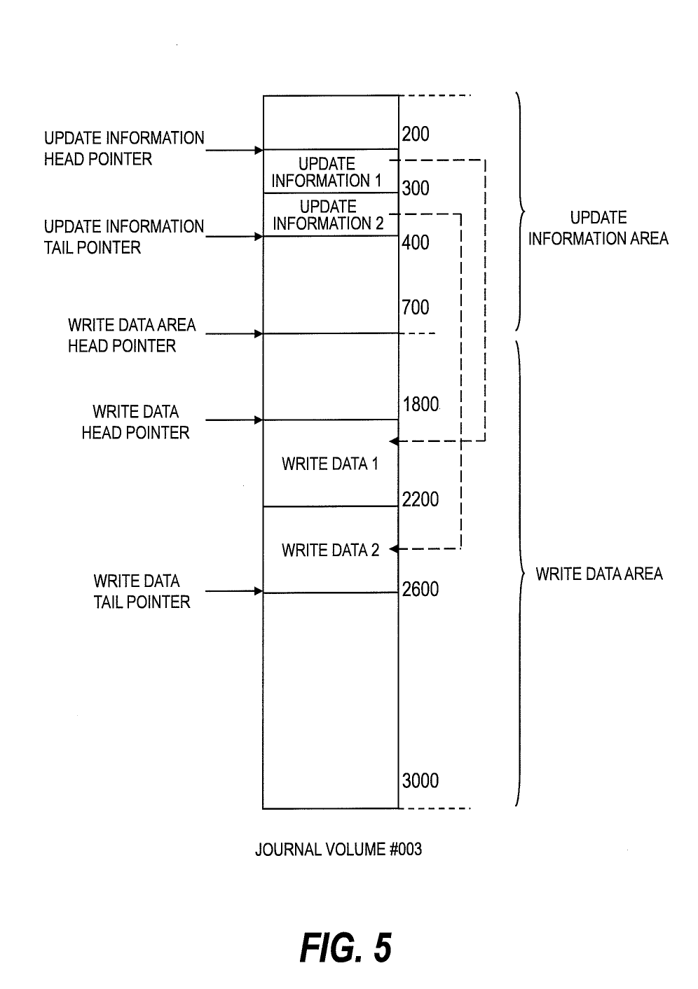

As shown in FIG. 5, the journal volume breaks one volume into a storage area (update information area) for storing update information, and a storage area (write data area) for storing write data. The update information is stored from a head of the update information area in order of update numbers. Upon storage of a tail end of the update information area, the update information is stored from the head of the update information area. The write data is stored from a head of the write data area. Upon storage of a tail end of the write data area, the write data is stored from the head of the write data area. The journal volume of the embodiment is provided as an intermediate buffer for transferring a journal used for remote copying to the storage system 4B in each of the primary and secondary storage systems 4A and 4B.

According to the embodiment, the storage area of the journal volume is divided into the storage area for storing update information (update information area) and the storage area for storing write data (write data area). However, a volume for storing update information and a volume for storing write data may separately be set in the disk drive 41. The update information and the write data may alternately be stored without division of the storage area of the journal volume into an update information area and a write data area.

The remote copying is a function mounted in the storage system 4. Between volumes (pair volumes) where a pair relation has been defined, data is replicated synchronously or asynchronously with a write request from the host computer 3, and data stored in one of the volumes is duplicated. The remote copying can be realized through, for example, execution of a remote copying program stored in a memory by a processor installed in the storage system 4. When a new pair relation is defined between volumes of the storage systems 4A and 4B, as an initial copy, data is replicated from the volume of the primary storage system 4A to the volume of the secondary storage system 4B with which the new pair relation has been defined.

In the case of remote copying for copying data synchronously with the write request, the primary storage system 4A that has received the write request from the host computer 3 stores write data contained in the write request in its own volume, and transfers the write data contained in the write request to the volume of the secondary storage system 4B with which the new pair relation has been defined. The secondary storage system 4B returns completion of the write request to the host computer 3 at a point of time when the write data transferred to the volume with which the pair relation has been defined is stored.

On the other hand, in the case of remote copying for copying data asynchronously with the write request, copying is carried out between the pair volumes independently (asynchronously) of the write request from the host computer 3. In other words, the storage system 4A returns completion of the write request to the host computer 3 at a point of time when the write data contained in the write request is stored in its own volume. According to the embodiment, asynchronous remote copying where the secondary storage system 4B requests remote copying of the primary storage system 4A is used.

The encryption/decryption function is realized through execution of an encryption/decryption program stored in the memory by the processor of the storage system 4. The encryption/decryption function may be realized by mounting hardware. When storing data in a volume of an encrypted status, the storage system 4 encrypts and stores data by the encryption/decryption function. The volume of the encrypted status means that data stored in the volume has been encrypted.

The management computer 5 manages the storage system 4. For example, a general-purpose computer can be used.

The management computer 5 includes hardware resources such as a processor, a memory, a network interface, and a local I/O device, and software resources such as a device driver, an OS, and a management program. The management computer 5 includes a RC/JNL function and an encryption/decryption function.

Under control of the processor, the management computer 5 executes various programs, and cooperates with the other hardware resources to realize a desired process. Specifically, the processor executes a management program on the OS to provide a user interface for managing the storage system 4 to the system administrator. Through an operation of the system administrator, setting, an execution instruction, and monitoring of an operation situation of the storage system 4 are managed. For example, based on the operation of the system administrator, the management computer 5 can set remote copying (defining of pair volumes or execution of initial copying), and an encrypted status of a data volume (enabling/disabling of the encryption function).

According to the embodiment, the storage system 4A is a primary storage system, and the storage system 4B is a secondary storage system. However, volume units of the storage system 4 may be divided into primary and secondary volumes, and data stored in the primary volume may be replicated (remote-copied) to the secondary volume.

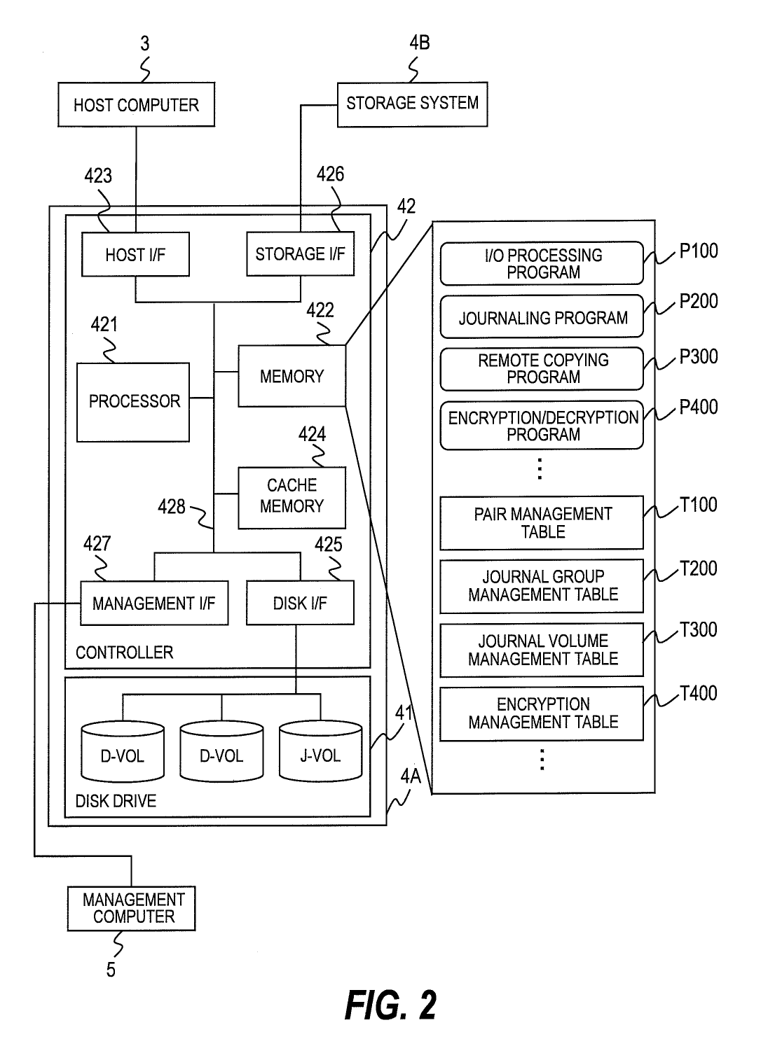

FIG. 2 illustrates a configuration of the storage system 4 according to the first embodiment of this invention.

The storage system 4 includes a disk drive 41 and a controller 42. The disk drive 41 is a physical device which includes a storage medium (e.g., a hard disk drive or a flash memory). The disk drive 41 and the controller 42 can be intercoupled via, for example, a disk channel.

The controller 42 includes a processor 421, a memory 422, a host interface 423, a cache memory 424, a disk interface 425, a storage interface 426, and a management interface 427. These components are intercoupled via an internal data line 428. Pluralities of components may be provided to make the configuration redundant.

The processor 421 executes various programs stored in the memory 422 to control the entire storage system 4.

The memory 422 stores an I/O processing program P100, a journaling program P200, a remote copying program P300, and an encryption/decryption program P400.

The I/O processing program P100 controls I/O access based on a write or read request from the host computer 3 to provide data storage services to the host computer 3.

Upon reception of a write request from the host computer 3, the journaling program P200 creates a journal entry (journal) based on write data contained in the received write request.

The remote copying program P300 executes a remote copying process among a plurality of storage systems 4 (between the storage systems 4A and 4B). The remote copying program P300 contains a subprogram for requesting remote copying and a subprogram to be requested for remote copying.

The encryption/decryption program P400 encrypts and stores data stored in a volume of the disk drive 41. The encryption/decryption program P400 decrypts the stored data when it reads the data.

The memory 422 stores system configuration information containing a pair management table T100, a journal group management table T200, a journal volume management table T300, and an encryption management table T400, and cache directory information.

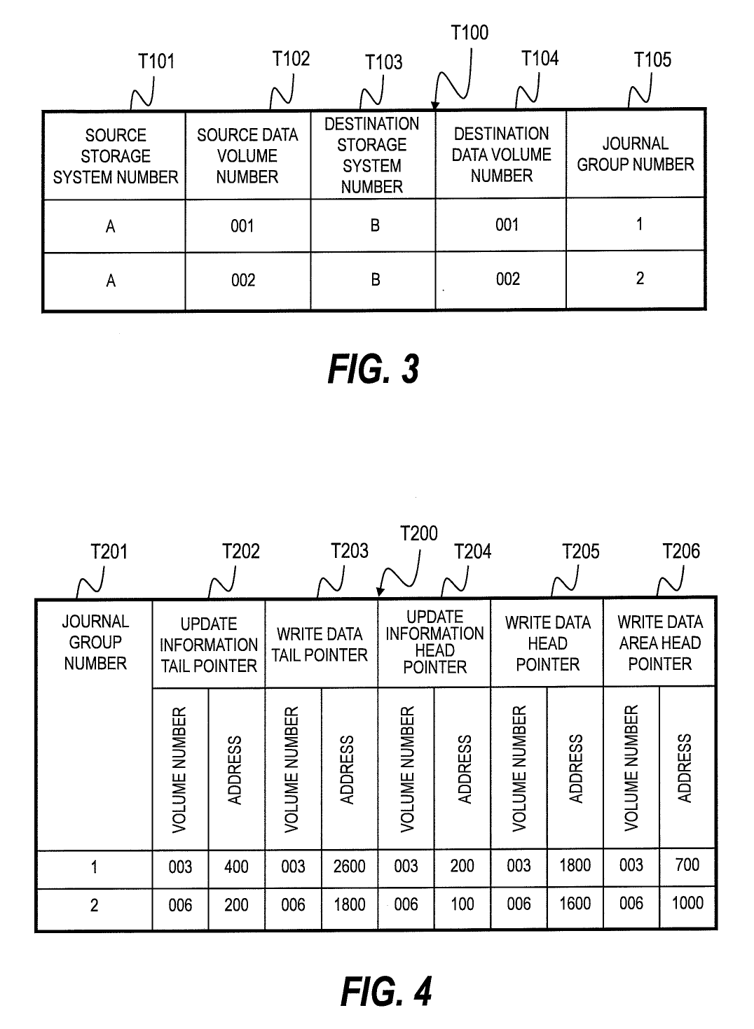

The pair management table T100 is for managing a pair relation of data volumes to be remote-copied. The pair management table T100 will be described below referring to FIG. 3.

The journal management table T200 is for managing journal volumes which store journals by journal group units. The journal group management table T200 will be described below referring to FIG. 4.

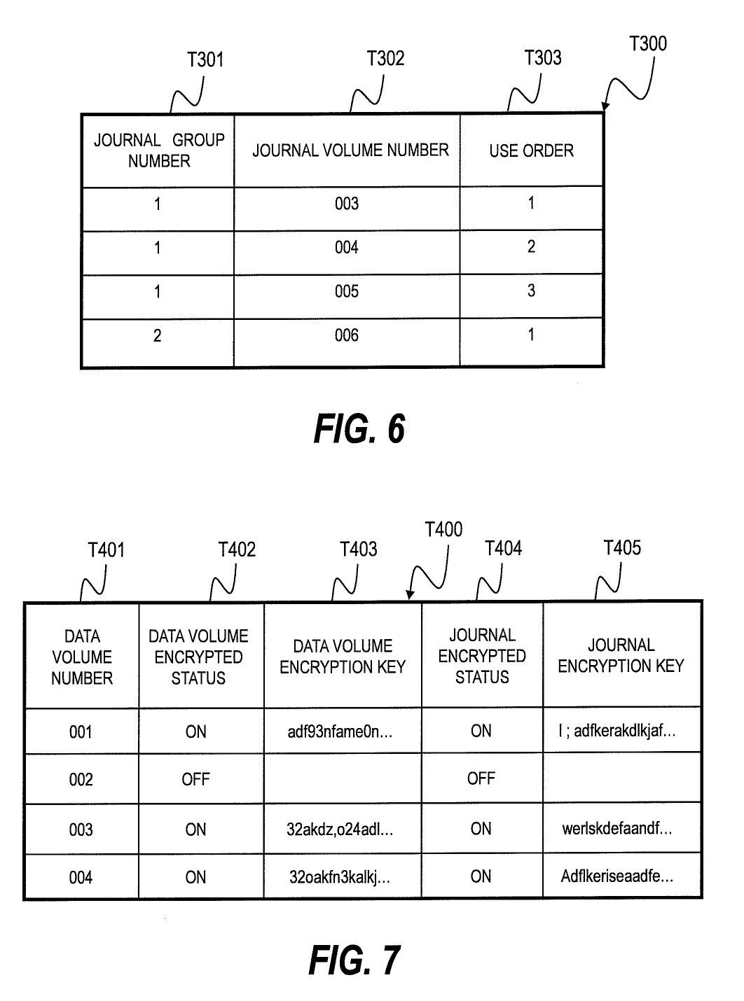

The journal volume management table T300 is for managing a journal volume of a journal group. The journal volume management table T300 will be described below referring to FIG. 6.

The encryption management table T400 is for managing encrypted statuses of a data volume of the storage system 4 and a journal stored in the data volume. The encryption management table T400 will be described below referring to FIG. 7.

The programs and some or all of the tables are read from an auxiliary storage system (not shown) to be stored in the memory 422. When the system administrator sets or changes system configuration information, the management computer 5 obtains the system configuration information stored in the memory 422, and provides the obtained system configuration information to the system administrator via the user interface.

The host interface 423 includes a protocol device (not shown) to communicate with the host computer 3 coupled via the storage network 2A. The protocol device includes a processor for executing a protocol process according to each protocol.

Upon reception of a write request from the host computer 3 by the host interface 423, the processor 421 writes write data contained in the received write request in the cache memory 424.

The cache memory 424 temporarily stores (caches) data input/output between the host computer 3 and the disk drive 41. In other words, the cache memory 424 is used for transferring data between the host interface 423 and the disk interface 425. The cache memory 424 can be configured by, for example, a volatile memory (DRAM) or a nonvolatile memory (flash RAM).

The disk interface 425 reads the data stored in the cache memory 424, and stores the read data in the disk drive 41 (destaging). The disk interface 425 reads the data from the disk drive 41, and stores the read data in the cache memory 424 (staging). For example, upon reception of a read request from the host computer 3, the disk interface 425 may judge whether requested data is present in the cache memory 424. If the requested data is not present in the cache memory 424, the disk interface 425 executes destaging to secure a cache area when necessary, and stages the requested data in the cache memory 424.

As in the case of the host interface 423, the storage interface 426 includes a protocol device (not shown) to communicate with the other storage system 4 coupled via the storage network 2A. When remote copying is carried out among a plurality of storage systems 4 (between the storage systems 4A and 4B), data is transferred via the storage interface 426.

The management interface 427 includes a protocol device (not shown) to communicate with the management computer 5 coupled via the management network 2B. For example, when the management network 2B is a LAN based on TCP/IP, the management interface 427 can use an Ethernet (registered trademark) board.

FIG. 3 illustrates the pair management table T100 according to the first embodiment of this invention. The pair management table T100 is created and updated by the system administrator who operates the management computer 5.

As shown in FIG. 3, the pair management table T100 includes a source storage system number T101, a source data volume number T102, a destination storage system number T103, a destination data volume number T104, and a journal group number T105.

A storage system number for identifying a storage system 4 which includes a data volume to be replicated by remote copying is registered in the source storage system number T101. The storage system number may be, for example, a vendor name or a production number of the storage system 4.

A volume number for identifying the data volume to be replicated by remote copying is registered in the source data volume number T102. For the volume number to be registered, any number can be employed as long as it can uniquely identify a specific volume among volumes of the storage system 4 identified by the source storage system number T101. In other words, for the volume number, a unique number is allocated irrespective of a type of a volume (whether a volume is a data volume or a journal volume).

A storage system number for identifying a storage system 4 which includes a data volume for storing replicated data is registered in the destination storage system number T103.

A volume number for identifying the data volume for storing the replicated data is registered in the destination data volume number T104. For the destination data volume number T104, any number can be employed as long as it can uniquely identify a data volume among volumes of the storage system 4 identified by the destination storage system number T103.

A number of a journal group for identifying a journal group to which a data volume of each entry belongs is registered in the journal group number T105. The journal group number T105 manages one or more data volumes (and one or more data volumes defined for pair relation therewith) by journal group units to guarantee an updating order of data between volumes defined for pair relation.

A plurality of data volumes may belong to one journal group. When a plurality of data volumes belong to one journal group, the plurality of data volumes share one journal volume. In other words, when remote copying is carried out, a journal group is defined for one or more data volumes so that an updating order of data stored in a plurality of data volumes of the primary storage system 4 can match that of data stored in data volumes of the secondary storage system 4. In the same journal group, unique updating numbers (sequential numbers) are allocated in updating order of data.

FIG. 4 illustrates the journal group management table T200 according to the first embodiment of this invention.

As shown in FIG. 4, the journal group management table T200 includes a journal group number T201, an update information tail pointer T202, a write data tail pointer T203, an update information head pointer T204, a write data head pointer T205, and a write data area head pointer T206.

A number for identifying a journal group is registered in the journal group number T201. In other words, a journal created based on a write request with respect to one or more data volumes is stored in a journal volume of a journal group to which a data volume which has received the write request belongs.

In the update information tail pointer T202, a volume number of a journal volume for storing update information and an address of a storage area for storing the update information are registered when the data stored in the data volume belonging to the journal group identified by the journal group number T201 is updated. In the address, an address next to a tail address of a storage area for storing update information generated immediately before is registered.

In the write data tail pointer T203, a volume number of a journal volume for storing write data and an address of a storage area for storing the write data are registered when the data stored in the data volume belonging to the journal group identified by the journal group number T201 is updated. In the address, an address next to a tail address of a storage are for storing write data generated latest is registered.

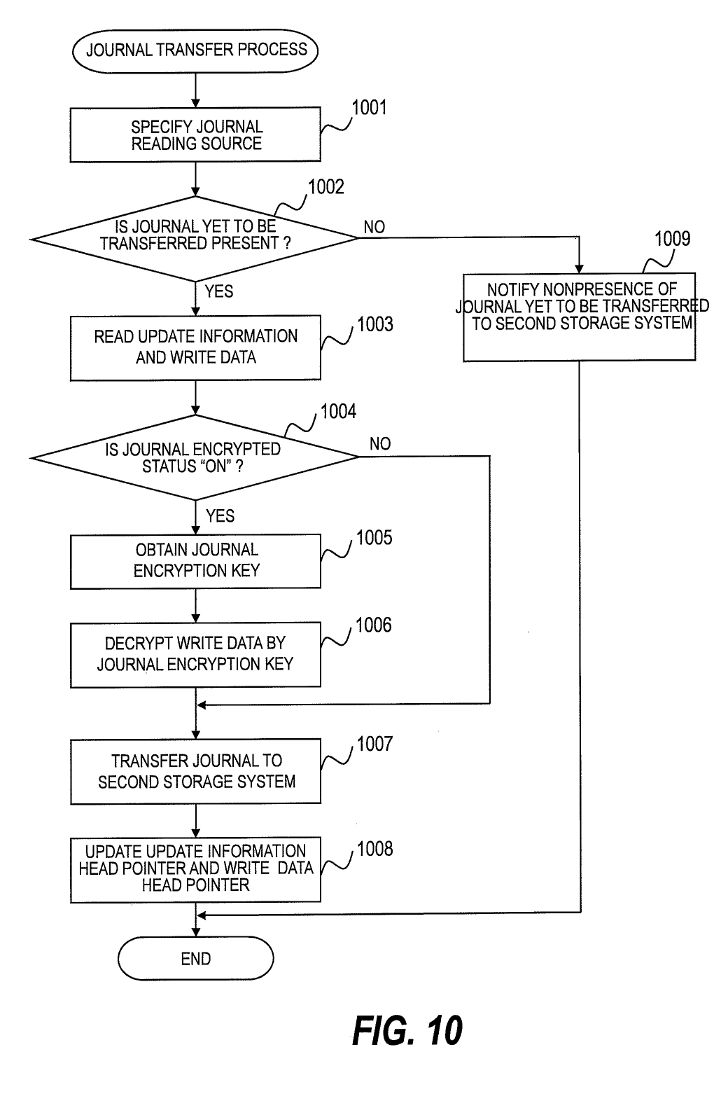

In the update information head pointer T204, a volume number of a journal volume for storing update information to be transferred next from the storage system 4A to the storage system 4B and an address of a storage area for storing the update information to be transferred are registered when a journal transfer process described below referring to FIG. 10 is carried out.

In the write data head pointer T205, a volume number of a journal volume for storing write data to be transferred next from the storage system 4A to the storage system 4B and an address of a storage area for storing the write data to be transferred are registered when the journal transfer process described below referring to FIG. 10 is carried out.

In the write data area head pointer T206, an address indicating a boundary between a storage area for storing the write data (write data area) and a storage area for storing the update information (update information area) among journal volume storage areas is registered.

In examples of FIGS. 4 and 5, an update information area is from a head to an address “699” of a storage area of a journal volume #003, and a write data area is from an address “700” to an address “2999” of a storage area of the journal volume #003. Update information is stored from an address “200” to an address “399” of a storage area of the journal volume #003. Next update information is stored from an address “400” of a storage area of the journal volume #003. Write data of a journal is stored from an address “1800” to an address “2599” of a storage area of the journal volume #003. Next write data is stored from an address “2600” of a storage area of the journal volume #003.

FIG. 6 illustrates the journal volume management table T300 according to the first embodiment of this invention.

As shown in FIG. 6, the journal volume management table T300 includes a journal group number T301, a journal volume number T302, and a use order T303.

In the journal group number T301, a number for identifying a journal group is registered.

In the journal volume number T302, an identifier of a journal volume corresponding to a journal group is registered.

In the use order T303, a value of an order of using journal volumes corresponding to a journal group is registered. Specifically, in the case of the journal volume management table T300 shown in FIG. 6, for journal volumes 003, 004, and 005 corresponding to a journal group whose journal group number T301 is “1”, journals are stored in an order of the journal volumes 003, 004 and 005. After storage of the journal in the journal volume 005, the process returns to the journal volume 003 to repeat storage of journals in the journal volumes.

FIG. 7 illustrates the encryption management table T400 according to the first embodiment of this invention.

As shown in FIG. 7, the encryption management table T400 includes a data volume number T401, a data volume encrypted status T402, a data volume encryption key T403, a journal encrypted status T404, and a journal encryption key T405.

In the data volume number T401, an identifier for identifying a data volume is registered. For the identifier, a volume number is used as described above.

In the data volume encrypted status T402, a flag indicating whether the data volume identified by the data volume number T401 has been encrypted is registered. The encrypted status is “ON” if the data volume has been encrypted, and “OFF” if not encrypted.

In the data volume encryption key T403, an encryption key for encrypting or decrypting a data volume is registered. For the encryption key, a predetermined encryption/decryption algorithm is used. For example, an encryption key having a length of 128 bits may be used. Encryption and decryption are complementary to each other, and the encryption key includes a decryption key according to the embodiment. An encrypted status of a volume means a status where access (writing or reading of data) to data stored in the volume is inhibited unless the encryption key (decryption key) is used, and a status where data encrypted by using the encryption key has been stored in the volume.

In the journal encrypted status T404, a flag indicating whether a journal created when a data volume is updated has been encrypted is registered. The encrypted status is “ON” if the journal has been encrypted, and “OFF” if not encrypted.

In the journal encryption key T405, an encryption key for encrypting or decrypting write data stored in a journal volume is registered.

The same encryption key may be allocated to a plurality of data volumes. For example, the same encryption key may be allocated to data volumes managed by the same manager. The encryption key for encrypting or decrypting the write data stored in the journal volume may be identical to the encryption key for encrypting or decrypting the data volume. According to the embodiment, one journal encryption key T405 is allocated to one data volume. When updating the encryption key, however, two or more journal encryption keys T405 may be allocated to one data volume.

The encryption key for encrypting or decrypting the data volume may be generated by timing of switching the data volume encrypted status T402 to “ON”. The journal encryption key T405 may be generated by the same timing as that of switching the data volume encrypted status T402 to “ON”. The journal encryption key T405 may be updated by the same timing as that of updating the data volume encryption key T403.

When contents registered in the journal encryption key T405 are deleted, the contents are deleted after confirmation of releasing of a pair relation defined for the data volume.

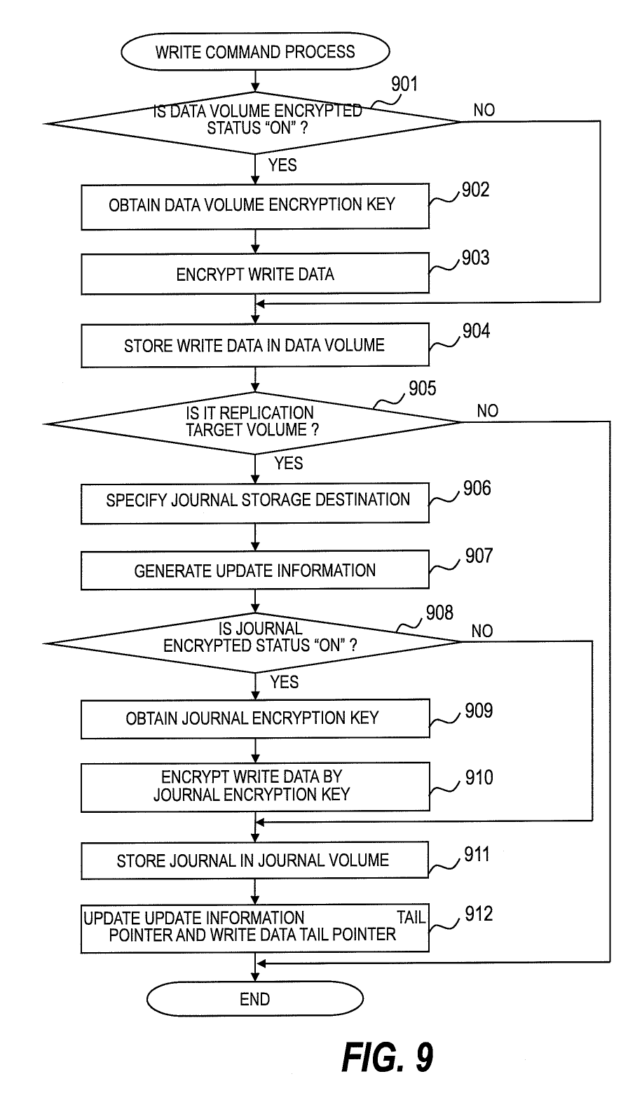

FIG. 9 is a flowchart of a write command process according to the first embodiment of this invention. Specifically, a process when the primary storage system 4A receives a write request with respect to a data volume from the host computer 3A will be described.

The write command process of FIG. 9 is carried out through execution of each program stored in the memory 422 by the processor 421 of the controller 42.

First, upon reception of a write request from the host computer 3A, the controller 42 of the storage system 4A (hereinafter, referred to as a controller 42A) refers to the encryption management table T400 stored in the memory 422 to judge whether an encrypted status of a data volume (D-VOL) designated by the received write request is “ON”, in other words, whether the data volume has been encrypted (901).

If the data volume has been encrypted, the process proceeds to step 902 to encrypt write data contained in the write request. On the other hand, if the data volume has not been encrypted, the process proceeds to step 904.

The controller 42A refers to the encryption management table T400 to obtain a data volume encryption key T403 allocated to the data volume judged to have been encrypted (902).

The controller 42A encrypts the write data contained in the received write request by using the encryption key obtained in step 902 (903). Specifically, when destaging data stored in the cache memory 424 to the disk drive 41, the processor 421 encrypts the write data by using the encryption key obtained in step 902. The processor 421 may encrypt the write data stored in the cache memory 424 to store it again in the cache memory 424. In this case, by predetermined timing, the encrypted write data stored in the cache memory 424 is destaged by the disk interface 425 according to cache directory information of the memory 422. The write request may be received from the host computer 3, and the write data contained in the write request may be encrypted before it is stored in the cache memory 424.

The controller 42A stores the write data in a data volume (904).

The controller 42A refers to the pair management table T100 to judge whether the data volume designated by the received write request has been set in the source data volume number T102 (905).

If the designated data volume has been set in the source data volume number T102, the process proceeds to step 906 to specify a storage destination of a journal journal volume for storing the journal) created based on the write request.

On the other hand, if the designated data volume has not been set in the source data volume number T102, the process is finished. In this case, the controller 42A notifies completion of the process to the host computer 3A which has transmitted the received write request.

The controller 42A refers to the journal management table T200 to obtain a volume number and an address registered in the update information tail pointer T202 and a volume number and an address registered in the write data tail pointer T203 (906). In other words, the controller 42A specifies a storage area of a journal volume for storing journals (update information and write data) based on the received write request.

The controller 42A generates update information based on the received write request (907).

The controller 42A refers to the encryption management table T400 to judge whether an encrypted status of a journal corresponding to a source data volume is “ON” (908).

If the encrypted status of the journal is “ON”, the process proceeds to step 909 to encrypt the write data. On the other hand, if the encrypted status of the journal is “OFF”, the process proceeds to step 911.

The controller 42A refers to the encryption management table T400 to obtain a journal encryption key T405 allocated to the source data volume (909).

The controller 42A encrypts the write data by using the journal encryption key T405 obtained in step 909 (910).

The controller 42A stores the update information and the write data as journals in the journal volume specified in step 906 (911).

The controller 42A updates the update information tail pointer T202 and the write data tail pointer T203 of the journal group management table T200 (912). Specifically, the controller 42A registers an address next to a tail address of the storage area for storing the update information in the update information tail pointer T202, and an address next to a tail address of the storage area for storing the write data in the write data tail pointer T203.

Then, the process is finished. In this case, the controller 42A notifies completion of the process to the host computer 3A which has transmitted the received write request.

In the flowchart of FIG. 9, the controller 42A stores the write data in the data volume in step 904, and then stores the journals in the journal volume in step 911. However, the process doesn't have to be executed in this order. In other words, the controller 42A may execute the step of storing the write data in the data volume and the step of storing the journals in the journal volume asynchronously.

FIG. 10 is a flowchart of a journal transfer process according to the first embodiment of this invention. Specifically, a process when the storage system 4A receives a remote copying request (hereinafter, referred to as a journal read request) will be described.

The journal transfer process of FIG. 10 is carried out through execution of each program stored in the memory 422 by the processor 421 of the controller 42A.

The storage system 4A provides, during a normal operation, data storage services to the host computer 3A, and carries out a remote copying process as a transmission side according to a journal read request from the storage system 4B.

First, upon reception of a journal read request from the storage system 4B which includes a data volume having a pair relation defined with a data volume of the storage system 4A, the controller 42A refers to the journal group management table T200 to extract an entry corresponding to the journal group number T201 contained in the journal read request, and obtains a volume number and an address registered in the update information tail pointer T202 of the extracted entry, and a volume number and an address registered in the update information head pointer T204 (1001).

The controller 42A judges whether a journal yet to be transferred to the storage system 4B is present (S1002). Specifically, the controller 42A judges whether the volume number and the address registered in the update information tail pointer T202 of the entry extracted in step 1001 match those registered in the update information head pointer T204.

If a journal yet to be transferred is present, in other words, if the volume number and the address registered in the update information tail pointer T202 don't match those registered in the update information head pointer T204, the process proceeds to step 1003 to read the journal yet to be transferred.

On the other hand, if a journal yet to be transferred is not present, in other words, if the volume number and the address registered in the update information tail pointer T202 match those registered in the update information head pointer T204, the process proceeds to step 1009.

Based on the volume numbers and the addresses registered in the update information head pointer T204 and the write data head pointer T205, the controller 42A reads, of journals stored in the journal volume, the oldest update information of a journal yet to be transferred and write data corresponding to the update information (1003).

The controller 42A refers to the encryption management table T400 to judge whether an encrypted status of the journal is “ON” based on the volume number of the data volume contained in the update information (1004).

If the encrypted status of the journal is “ON”, the process proceeds to step 1005 to decrypt the encrypted write data. If the encrypted status of the journal is “OFF”, on the other hand, the process proceeds to step 1007.

The controller 42A refers to the encryption management table T400 to obtain the journal encryption key T405 allocated to the data volume identified by the volume number contained in the update information (1005).

The controller 42A decrypts the write data read in step 1003 by using the journal encryption key T405 obtained in step 1005 (1006).

The controller 42A transmits the journals (update information and write data) to the storage system 4B (1007).

The controller 42A updates the update information head pointer T204 and the write data head pointer T205 of the corresponding entry in the journal group management table T200 based on volumes of the update information and the write data transmitted in step 1007 (1008). Specifically, the controller 42A registers a head address of a storage area storing the update information of a journal yet to be transferred in the address of the update information head pointer T204, and a head address of a storage area storing the write data of the journal yet to be transferred in the write data head pointer T205. Then, the process is finished.

In step 1009, the controller 42A transmits a response indicating nonpresence of a journal yet to be transferred to the controller 42 of the storage system 4B (1009). Then, the process is finished.

According to the embodiment, the storage system 4A transfers the journals according to the journal read request from the storage system 4B. However, the storage system 4A may periodically transfer journals to the storage system 4B. The storage system 4A may receive a write request from the host computer 3A, and transfer journals created based on the write request to the storage system 4B.

The update information may contain a flag indicating an encrypted status of a journal, and in step 1004 of judging the encrypted status of the journal, the encrypted status of the journal may be judged by referring to the flag contained in the update information. The update information may contain an identifier indicating a journal encryption key, and in step 1005 of obtaining the encryption key, the journal encryption key may be obtained by referring to the identifier contained in the update information.

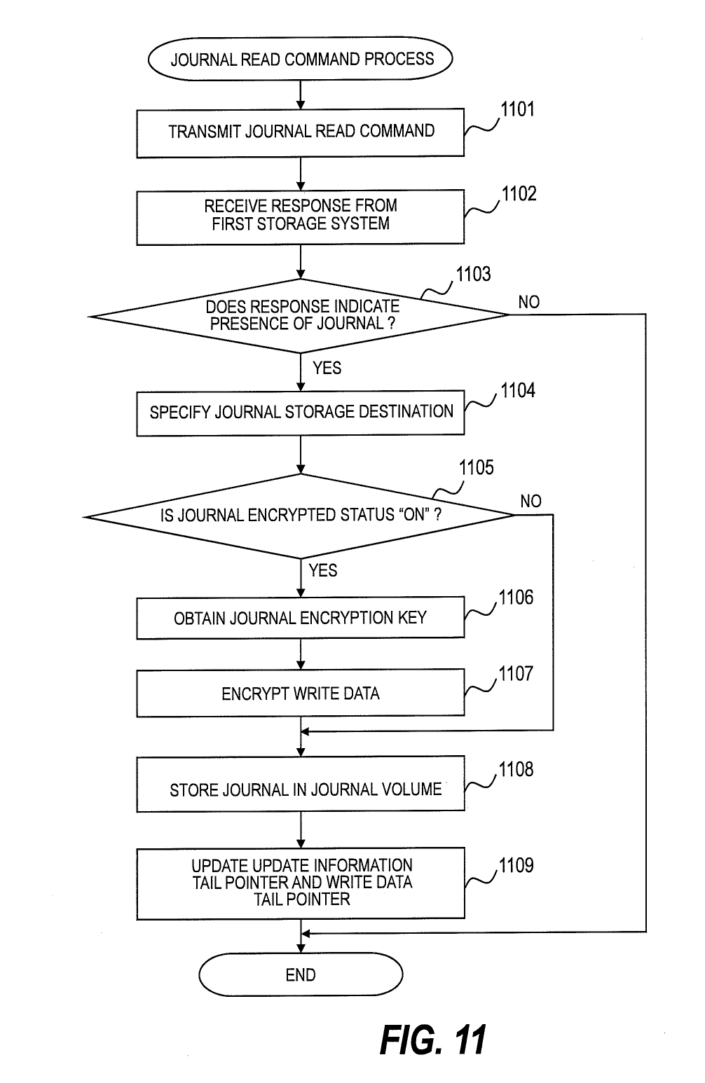

FIG. 11 is a flowchart of a journal read command process according to the first embodiment of this invention. Specifically, a process when the storage system 4B transmits a journal read request to the storage system 4A will be described.

The journal read command process of FIG. 11 is carried out through execution of each program stored in the memory 422 by the processor 421 of the controller 42.

First, the controller 42 of the storage system 4B (hereinafter, referred to as a controller 42B) transmits a journal read request to the storage system 4A (1101).

The controller 42B receives a response of the journal read request from the storage system 4A (1102).

The controller 42B judges whether the response received in step 1102 is a journal (1103).

If the received response is a journal, the process proceeds to step 1104. On the other hand, if the received response is not a journal, in other words, if the response is a notification of nonpresence of a journal yet to be transferred, the process is finished.

The controller 42B refers to the journal group management table T200 to obtain a volume number and an address of a journal volume for storing the received journal based on an address of a write request contained in the update information of the received journal, and specifies a storage destination of the journal journal volume for storing the journal) (1104).

The controller 42B refers to the encryption management table T400 to judge whether an encrypted status of the journal corresponding to a destination volume is “ON” (1105).

If the encrypted status of the journal is “ON”, the process proceeds to step 1106 to encrypt write data of the received journal. On the other hand, if the encrypted status of the journal is “OFF”, the process proceeds to step 1108.

The controller 42B refers to the encryption management table T400 to obtain the journal encryption key T405 allocated to a data volume identified by the volume number contained in the update information (1106).

The controller 42B encrypts write data of the received journal by using the journal encryption key T405 obtained in step 1106 (1107).

The controller 42B stores the journals (update information and write data) in the journal volume specified in step 1104 (1108).

The controller 42B updates the update information tail pointer T202 and the write data tail pointer T203 of the corresponding entry in the journal group management table T200 (1109). Specifically, the controller 42B registers an address next to a tail address of a storage area storing the update information in the update information tail pointer T202, and an address next to a tail address of a storage area storing the write data in the write data tail pointer T203. Then, the process is finished.

The update information may contain a flag indicating an encrypted status of a journal, and in step 1105 of judging the encrypted status of the journal, the encrypted status of the journal may be judged by referring to the flag contained in the update information. The update information may contain an identifier indicating a journal encryption key, and in step 1106 of obtaining the encryption key, a journal encryption key may be obtained by referring to the identifier contained in the update information.

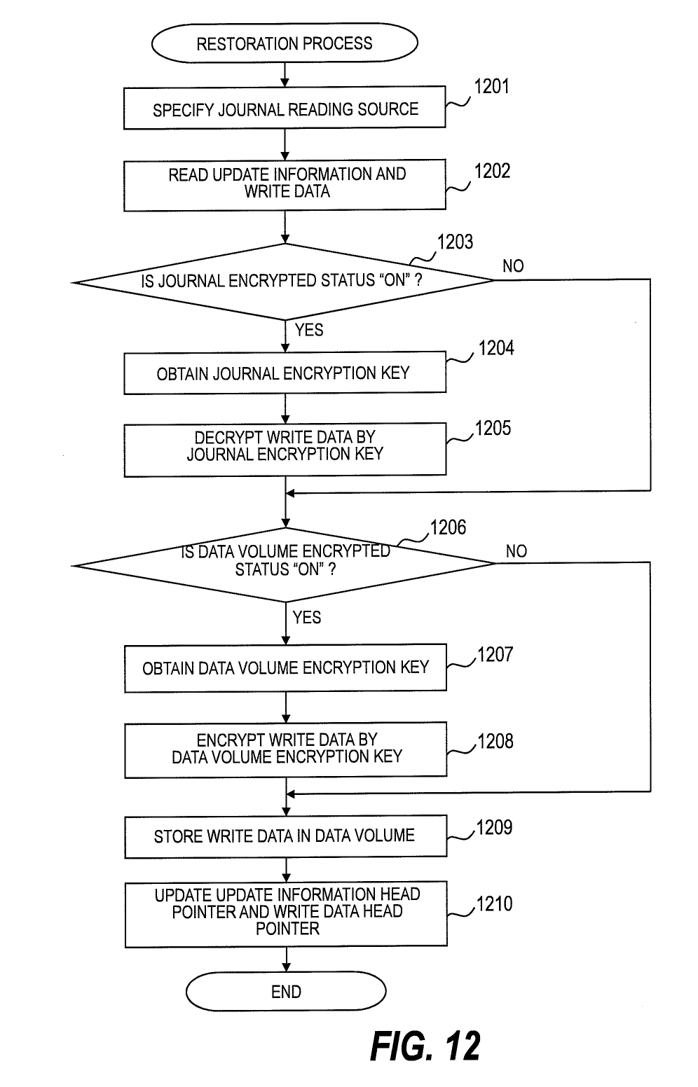

FIG. 12 is a flowchart of a restoration process according to the first embodiment of this invention. Specifically, a process of creating a replication of a data volume based on a journal received from the storage system 4A by the storage system 4B will be described.

The restoration process of FIG. 12 is carried out through execution of each program stored in the memory 422 by the processor 421 of the controller 42B.

First, the controller 42B refers to the journal group management table T200 to extract a volume number and an address registered in the update information head pointer T204 and a volume number and an address registered in the write data head pointer T205, and specifies a journal volume for reading ajournal (1201).

Update information and write data are read from storage areas indicated by the volume numbers and the addresses extracted in step 1201 (1202).

The controller 42B refers to the encryption management table T400 to judge whether an encrypted status of a journal corresponding to a destination data volume is “ON” based on an address of a write request contained in the update information of the journal (1203).

If the encrypted status of the journal is “ON”, the process proceeds to step 1204 to decrypt the write data of the journal. If the encrypted status of the journal is “OFF”, the process proceeds to step 1206.

The controller 42B refers to the encryption management table T400 to obtain the journal encryption key T405 allocated to the destination data volume (1204).

The controller 42B decrypts the encrypted write data by using the journal encryption key T405 obtained in step 1204 (1205).

The controller 42B refers to the encryption management table T400 to judge whether an encrypted status of the destination data volume is “ON” (1206).

If the encrypted status of the destination data volume is “ON”, the process proceeds to step 1207 to encrypt the write data to be stored in the data volume. On the other hand, if the encrypted status of the destination data volume is “OFF”, the process proceeds to step 1209.

The controller 42B refers to the encryption management table T400 to obtain the data volume encryption key T403 allocated to the destination data volume (1207).

The controller 42B encrypts the write data by using the data volume encryption key T403 obtained in step 1207 (1208).

The controller 42B stores the write data in the destination data volume (1209).

The controller 42B updates the update information head pointer T204 and the write data head pointer T205 of the corresponding entry in the journal group management table T200 based on volumes of the update information and the write data (1210). Specifically, the controller 42B registers a head address of a storage area storing the update information in an address of the update information head pointer T204, and a head address of a storage area storing the write data in the write data head pointer T205. Then, the process is finished.

According to the first embodiment of this invention, during the journal transfer process in the remote copying, based on the volume number contained in the update information, the encrypted status of the journal and the journal encryption key used for encrypting the write data are obtained by referring to the encryption management table T400, and the decrypted journal is transferred to the destination storage system 4. Thus, even when journals encrypted by different encryption keys are mixed in the same journal volume, remote copying can be realized by decrypting the journals by proper encryption keys.

According to the first embodiment, when creating a list for managing the journal encryption key, the list for managing the journal encryption key is created corresponding to the data volume. Thus, an increase in volume of the list for managing the journal encryption key can be suppressed.

### Second Embodiment

According to a second embodiment of this invention, a storage system 4 provides a backup function which uses a journaling function called continuous data protection. The continuous data protection is a function of restoring a data volume to a data volume of a particular point of time, and realized by holding a snapshot of the data volume of the particular point of time and journals created based on write requests received at a time of creating the snapshot and after, and applying the journals to data stored in the data volume at the point of time of creating the snapshot in an order of reception of the write requests.

A data volume can be restored to a status of an optional point of time before the point of time of creating the snapshot by holding journals created based on write requests before the point of time of creating the snapshot, and rewriting journals from the created snapshot.

Differences from the first embodiment will be described.

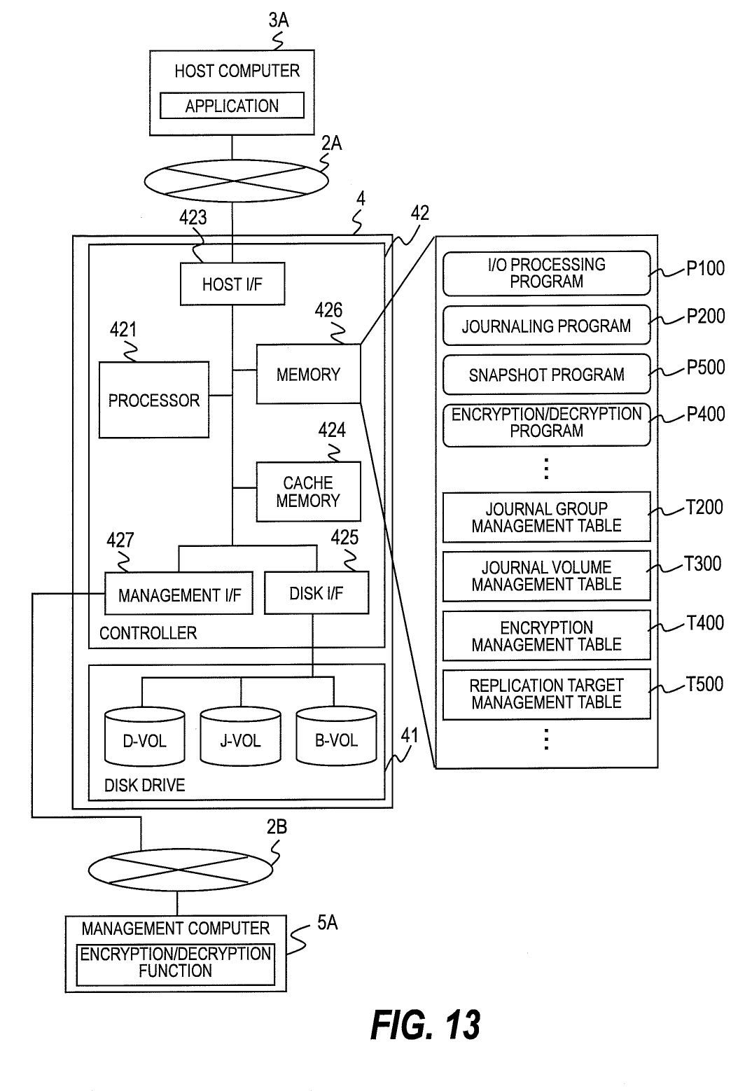

FIG. 13 illustrates a configuration of a computer system according to the second embodiment of this invention.

The storage system 4 of the second embodiment includes a basic volume (B-VOL) for storing data of a data volume of a particular point of time of creating a snapshot. A memory 426 stores a snapshot program P500 for managing a snapshot. The memory 426 stores a replication target management table T500 in place of the pair management table T100 of the first embodiment.

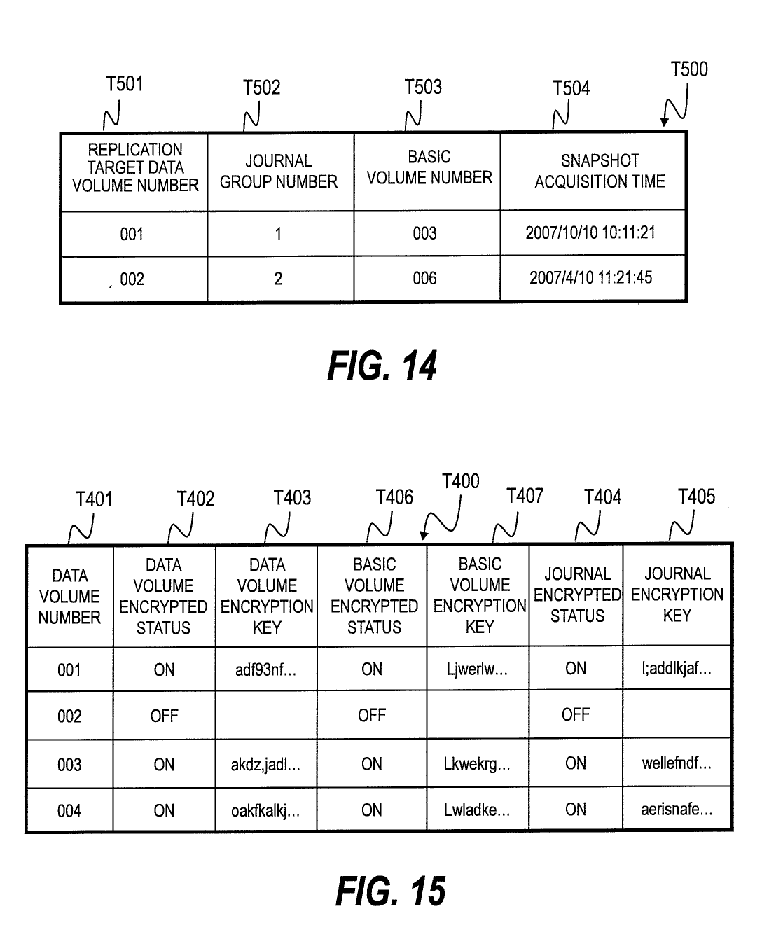

FIG. 14 illustrates the replication target management table T500 according to the second embodiment of this invention.

The replication target management table T500 is for managing a data volume to be backed up, a journal group to which the data volume to be backed up belongs, a basic volume for storing data of a data volume of a particular point of time of creating a snapshot, and the time of creating the snapshot. The replication target management table T500 is created or updated by a system administrator who operates a management computer 5.

As shown in FIG. 14, the replication target management table T500 includes a replication target data volume number T501, a journal group number T502, a basic volume number T503, and snapshot acquisition time T504.

In the replication target data volume number T501, a volume number for identifying a data volume to be backed up is registered. For the volume number to be registered, any number can be employed as long as it can uniquely specify a specific volume from among volumes of the storage system 4.

In the journal group number T502, a number of a journal group for identifying a journal group to which a data volume of each entry belongs is registered.

In the basic volume number T503, a volume number of a basic volume for storing data of a data volume of a particular time of creating a snapshot is registered.

In the snapshot acquisition time T504, the time of creating the snapshot of the data stored in the basic volume is registered.

By setting a plurality of basic volumes in correspondence to the data volume to be backed up, a plurality of snapshots created at different points of time may be stored in the basic volumes.

FIG. 15 illustrates an encryption management table T400 according to the second embodiment of this invention. The encryption management table T400 of the second embodiment is for managing encrypted statuses and encryption keys of a data volume, a journal volume, and a basic volume of the storage system 4.

As shown in FIG. 15, the encryption management table T400 of the second embodiment includes a data volume number T401, a data volume encrypted status T402, a data volume encryption key T403, a basic volume encrypted status T406, a basic volume encryption key T407, a journal encrypted status T404, and ajournal encryption key T405.

The data volume number T401, the data volume encrypted status T402, the journal encrypted status T404, and the journal encryption key T405 are similar to those of the encryption management table T400 of the first embodiment, and thus description thereof will be omitted.

In the basic volume encrypted status T406, a flag indicating whether a basic volume identified by the basic volume number T503 of the replication target management table T500 has been encrypted is registered.

In the basic volume encryption key T407, if the encrypted status of the basic volume is “ON”, an encryption key for encrypting or decrypting data stored in the basic volume is registered.

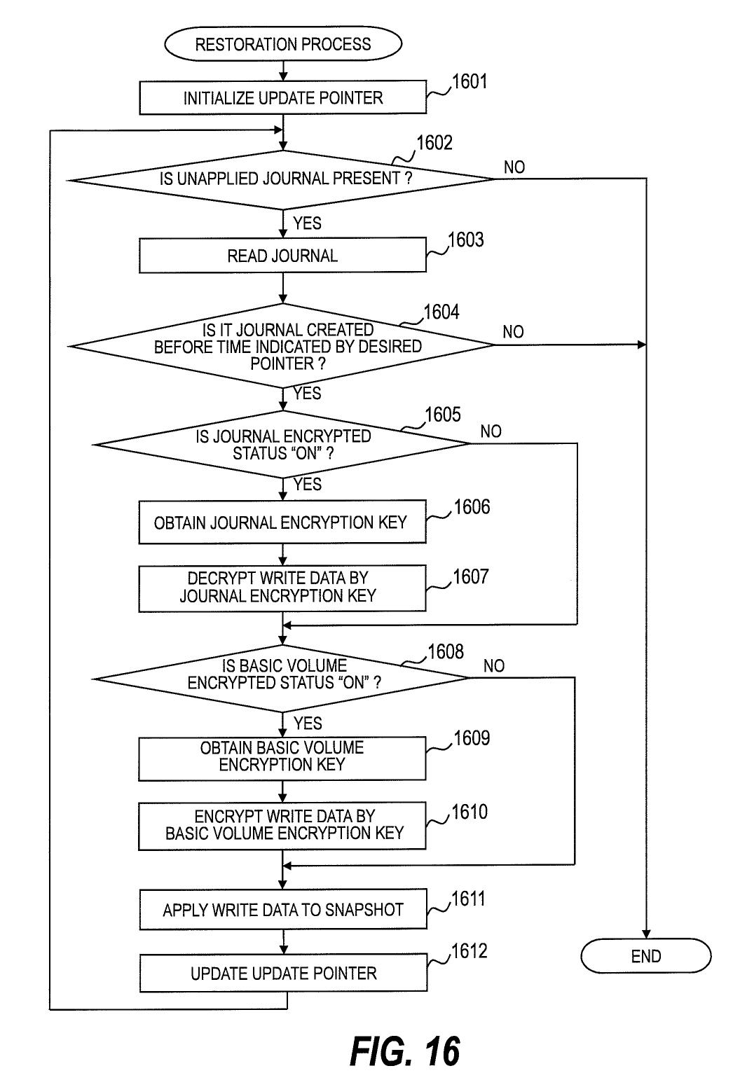

FIG. 16 is a flowchart of a restoration process according to the second embodiment of this invention. Specifically, a process when the storage system 4 receives a restoration request of a data volume from a management computer 5 will be described.

The restoration request is a request for restoring a data volume of a particular point of time, and includes a desired pointer for designating a point of time of requesting restoration.

The restoration process of FIG. 16 is carried out through execution of each program stored in a memory 422 by a processor 421 of the controller 42.

First, the controller 42 initializes an update pointer (1601). Specifically, in the update pointer, a volume number and an address of a journal volume storing the oldest journal of the journals not applied to a snapshot are set.

The controller 42 judges whether the update pointer matches an update information tail pointer T202, in other words, whether a journal not applied to a snapshot is present in a journal volume (1602).

If the update pointer doesn't match the update information tail pointer T202, in other words, if a journal not applied to a snapshot is present in the journal volume, the process proceeds to step 1603. If the update pointer matches the update information tail pointer T202, in other words, if a journal not applied to a snapshot is not present, the process is finished.

The controller 42 reads journals (update information and write data) from a storage area indicated by the update pointer (1603).

The controller 42 judges whether the journals read in step 1603 are journals created before a point of time designated by a desired pointer included in a restoration request (1604).

If the read journals are journals created before the point of time designated by the desired pointer, the process proceeds to step 1605. On the other hand, if the read journals are not journals created before the point of time designated by the desired pointer, in other words, if restoration of a data volume of the point of time designated by the desired pointer has been completed, the process is finished.

The controller 42 refers to the encryption management table T400 to judge whether an encrypted status of a journal is “ON” based on the data volume number T401 contained in the update information (1605).

If the encrypted status of the journal is “ON”, the process proceeds to step 1606 to decrypt the write data. On the other hand, if the encrypted status of the journal is “OFF”, the process proceeds to step 1206.

The controller 42 refers to the encryption management table T400 to obtain a journal encryption key T405 allocated to a data volume (1606).

The controller 42 decrypts the encrypted write data by using the journal encryption key T405 obtained in step 1606 (1607).

The controller 42 refers to the replication target management table T500 to judge whether an encrypted status of a basic volume to which a journal is applied is “ON” based on the data volume number T401 contained in the update information (1608).

If the encrypted status of the basic volume is “ON”, the process proceeds to step 1609 to encrypt the write data. On the other hand, if the encrypted status of the basic volume is “OFF”, the process proceeds to step 1611.

The controller 42 refers to the encrypted status management table T400 to obtain the basic volume encryption key T407 allocated to the basic volume (1609).

The controller 42 encrypts the write data by using the basic volume encryption key T407 obtained in step 1609 (1610).

The controller 42 applies journals to a snapshot by storing the write data in the basic volume (1611).

The controller 42 updates the update pointer (1612). Specifically, the controller 42 sets, in the update pointer, a new volume number and a new address of a journal volume where the oldest journal has been stored of the journals not applied to the snapshot. Then, the process returns to step 1602.

According to the second embodiment of this invention, in the journaling function which uses the continuous data protection, the encrypted status of the journal and the journal encryption key used for encrypting the write data are obtained based on the volume number contained in the update information, and the journal is decrypted by a proper encryption key. Thus, even when journals encrypted by different encryption keys are mixed in the same journal volume, the journals are decrypted by proper encryption keys to realize continuous data protection.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising:
a host computer; and
a first storage system coupled to the host computer:
wherein the first storage system includes
a first controller for controlling the first storage system,
a first volume for storing data written by the host computer and
a second volume for storing updated data when the data stored in the first volume is updated; and
wherein the first controller is configured to
generate update information based on write data contained in the write request upon reception of a write request from the host computer,
encrypt the write data based on an encrypted status of the data stored in the second volume and an encryption key for encrypting the data stored in the second volume and
store the generated update information and the encrypted write data in the second volume.

2. The computer system according to claim 1, wherein the first controller manages encryption management information which includes an encrypted status indicating whether the data stored in the first volume has been encrypted, an encryption key for encrypting the data stored in the first volume, an encrypted status indicating whether the data stored in the second volume has been encrypted, and an encryption key for encrypting the data stored in the second volume.

3. The computer system according to claim 1, further comprising a second storage system coupled to the first storage system,
wherein the first controller is configured to:
read the update information and the write data stored in the second volume;
decrypt the write data based on an encrypted status of the read write data and an encryption key for decrypting the read write data; and
transmit the update information and the decrypted write data to the second storage system.

4. The computer system according to claim 3:
wherein the second storage system includes
a second controller for controlling the second storage system,
a third volume for storing a replication of the data of the first volume and
a fourth volume for storing the updated data when data stored in the third volume is updated, and
wherein the second controller is configured to
specify the fourth volume for storing the update information and the write data which have been transmitted,
judge whether to encrypt the write data based on an encrypted status of the data stored in the fourth volume,
obtain, when the write data is encrypted, an encryption key for encrypting the data stored in the fourth volume,
encrypt the transmitted write data by using the obtained encryption key, and
store the update information and the encrypted write data in the specified fourth volume.

5. The computer system according to claim 4, wherein the second controller is configured to:
read the update information and the write data from the specified fourth volume;
judge whether the write data has been encrypted based on the read update information;
obtain an encryption key for decrypting the write data in the case of which the write data has been encrypted;
decrypt the write data by using the obtained encryption key; and
store the decrypted write data in the third volume.

6. The computer system according to claim 4, wherein the second controller is configured to:
read the update information and the write data from the specified fourth volume;
judge whether the write data has been encrypted based on the read update information;
obtain an encryption key for decrypting the write data in the case of which the write data has been encrypted;
decrypt the write data by using the obtained encryption key;
judge whether the data stored in the third volume has been encrypted;
obtain an encryption key for encrypting the data stored in the third volume in the case of which the data stored in the third volume has been encrypted;
encrypt the write data by using the obtained encryption key; and
store the encrypted write data in the third volume.

7. A storage system, comprising:
an interface coupled to a host computer;
a controller for controlling the storage system;
a first volume for storing data written by the host computer; and
a second volume for storing the updated data when the data stored in the first volume is updated,
wherein the controller is configured to:
generate update information based on write data contained in the write request upon reception of a write request from the host computer;
encrypt the write data based on an encrypted status of the data stored in the second volume and an encryption key for encrypting the data stored in the second volume; and
store the generated update information and the encrypted write data in the second volume.

8. The storage system according to claim 7, further comprising a third volume for storing snapshot data of the first volume at time of creating the snapshot,
wherein the controller is configured to:
judge whether data updated after the time of creating the snapshot is stored in the second volume;
read update information and write data stored in the second volume after the time of creating the snapshot in the case of which data updated after the time of creating the snapshot is stored in the second volume;
judge whether the write data has been encrypted based on the read update information;
obtain an encryption key for decrypting the write data in the case of which it is judged that the write data has been encrypted;
decrypt the write data by using the obtained encryption key; and
store the decrypted write data in the third volume.

9. The storage system according to claim 8, wherein the controller is configured to:
judge whether the data stored in the third volume has been encrypted;
obtain an encryption key for encrypting the data stored in the third volume in the case of which the data stored in the third volume has been encrypted;
encrypt the write data by using the obtained encryption key; and
store the encrypted write data in the third volume.

10. A remote copying method executed in a computer system which includes a host computer and a first storage system coupled to the host computer,
the first storage system including a first volume for storing data written by the host computer and a second volume for storing the updated data when the data stored in the first volume is updated,
the remote copying method comprising the steps of:
generating, by the storage system, update information based on write data contained in the write request upon reception of a write request from the host computer;
encrypting, by the storage system, the write data based on an encrypted status of the data stored in the second volume and an encryption key for encrypting the data stored in the second volume; and
storing the generated update information and the encrypted write data in the second volume.

11. The remote copying method according to claim 10, wherein:
the first storage system includes a first controller for controlling the first storage system; and
the first controller manages encryption management information which includes an encrypted status indicating whether the data stored in the first volume has been encrypted, an encryption key for encrypting the data stored in the first volume, an encrypted status indicating whether the data stored in the second volume has been encrypted, and an encryption key for encrypting the data stored in the second volume.

12. The remote copying method according to claim 10, wherein:
the computer system further includes a second storage system coupled to the first storage system; and
the remote copying method further comprises the steps of:
reading, by the first controller, the update information and the write data stored in the second volume;
decrypting, by the first controller, the write data based on an encrypted status of the read write data and an encryption key for decrypting the read write data; and
transmitting, by the first controller, the update information and the decrypted write data to the second storage system.

13. The remote copying method according to claim 12, wherein:
the second storage system includes a third volume for storing a replication of the data of the first volume and a fourth volume for storing the updated data when data stored in the third volume is updated, and the remote copying method further comprises the steps of:
specifying, by the second controller, the fourth volume for storing the update information and the write data which have been transmitted;
judging, by the second controller, whether to encrypt the write data based on an encrypted status of the data stored in the fourth volume;
obtaining, by the second controller, an encryption key for encrypting the data stored in the fourth volume when the write data is encrypted;
encrypting, by the second controller, the transmitted write data by using the obtained encryption key; and
storing, by the second controller, the update information and the encrypted write data in the specified fourth volume.

14. The remote copying method according to claim 13, further comprising the steps of:
reading, by the second controller, the update information and the write data from the specified fourth volume;
judging, by the second controller, whether the write data has been encrypted based on the read update information;
obtaining, by the second controller, an encryption key for decrypting the write data in the case of which the write data has been encrypted;
decrypting, by the second controller, the write data by using the obtained encryption key; and
storing, by the second controller, the decrypted write data in the third volume.

15. The remote copying method according to claim 13, further comprising the steps of:
reading, by the second controller, the update information and the write data from the specified fourth volume;
judging, by the second controller, whether the write data has been encrypted based on the read update information;
obtaining, by the second controller, an encryption key for decrypting the write data in the case of which the write data has been encrypted;
decrypting, by the second controller, the write data by using the obtained encryption key;
judging whether the data stored in the third volume has been encrypted;
obtaining, by the second controller, an encryption key for encrypting the data stored in the third volume in the case of which the data stored in the third volume has been encrypted;
encrypting, by the second controller, the write data by using the obtained encryption key; and
storing the encrypted write data in the third volume.

16. The remote copying method according to claim 10, wherein:
the first storage system includes a fifth volume for storing snapshot data of the first volume at time of creating the snapshot; and
the remote copying method further comprises the steps of:
judging, by the first controller, whether data updated after the time of creating the snapshot is stored in the second volume;
reading, by the first controller, update information and write data stored in the second volume after the time of creating the snapshot in the case of which data updated at and after the point of time of creating the snapshot is stored in the second volume;
judging, by the first controller, whether the write data has been encrypted based on the read update information;
obtaining, by the first controller, an encryption key for decrypting the write data in the case of which it is judged that the write data has been encrypted;
decrypting, by the first controller, the write data by using the obtained encryption key; and
storing, by the first controller, the decrypted write data in the fifth volume.

17. The remote copying method according to claim 16, further comprising the steps of:
judging, by the first controller, whether the data stored in the fifth volume has been encrypted;
obtaining, by the first controller, an encryption key for encrypting the data stored in the fifth volume in the case of which the data stored in the fifth volume has been encrypted; and
encrypting, by the first controller, the write data by using the obtained encryption key,
wherein the step of storing the data in the fifth volume includes the step of storing the encrypted write data in the fifth volume.
